(19) United States
(12) Patent Application Publication
(10) Pub. No.: US 2025/0107866 A1
(43) Pub. Date: Apr. 3, 2025

(54) SYSTEM AND METHOD FOR LASER BASED TREATMENT OF DENTAL HARD TISSUE

(71) Applicant: Convergent Dental, Inc., Waltham, MA (US)

(72) Inventors: Charles Kerbage, Arlington, MA (US); Vijay Ramareddy, Providence, RI (US)

(21) Appl. No.: 18/901,806

(22) Filed: Sep. 30, 2024

Related U.S. Application Data
(60) Provisional application No. 63/541,951, filed on Oct. 2, 2023.

(51) Int. Cl. A61C 1/00

(52) U.S. Cl. CPC A61C 1/0046

(57) ABSTRACT

A method for treating dental hard tissue to decrease sensitivity by occluding dentin tubules. A CO₂ laser source generates a pulsed laser beam having a wavelength of 9-11 microns. A laser beam width is defined and the pulsed laser beam focused at or near the dental hard tissue. A pulse energy is controlled with at least one beam pulse having a fluence profile in a working range of the laser beam having:
a maximum local fluence less than a minimum fluence that causes damage of the dental hard tissue, and
at least one other local fluence greater than a fluence that causes a minimum amount of occlusion of the dentin tubules.
   The pulsed laser beam is directed to respective dental hard tissue locations to occlude the dentin tubules, without delivery of cooling fluid while directing the pulsed laser beam to respective tissue locations.

### RELATED APPLICATION

This application claims priority to and the benefit of U.S. Patent Application Ser. No. 63/541,951, filed Oct. 2, 2023, the entire contents of which are incorporated herein by reference.

### FIELD OF THE INVENTION

Embodiments of the present invention generally relate to the treatment of hard tissue using a light-emitting device (e.g., a laser source), and, more particularly, to treatment of teeth sensitivity by directing radiation emitted by a laser source to an area of dental hard tissue that produces sensitivity, with or without application of topical solutions prior to or after irradiation.

### BACKGROUND OF THE INVENTION

The mineral phase of human teeth consists of calcium phosphate in the form of hydroxyapatite, Ca₅(PO₄)₃(OH). Enamel, the outer part of a tooth, is a highly mineralized tissue containing about 97% in weight hydroxyapatite. Dentin, the layer between enamel and pulp, contains about 70% in weight hydroxyapatite. See M Goldberg, A. B. Kulkarni, M Young, and A Boskey, (2011), Dentin: Structure, Composition and Mineralization, Front Biosci (Elite Ed). 3:711-735, incorporated by reference herein in its entirety. The structure of dentin consists of tubules encompassing empty space with diameters of 1-3 microns. When dentin is exposed, the tubules allow external stimuli to be felt as sharp pain when the exposed dentin is contacted by acidic foods or hot or cold foods. This sensitivity is often called teeth hypersensitivity. Hypersensitivity is one of the most common dental problems, affecting over 40% of adults worldwide. See M Asnaashari, M Moeini, (2013) Effectiveness of Lasers in the Treatment of Dentin Hypersensitivity, J Lasers Med Sci. 4(1):1-7, incorporated by reference herein in its entirety.

In a typical treatment process, a temporary blocking of dentinal tubules is achieved using topical reagents. These reagents enter the tubules, and block the external stimuli from reaching the nerves in the pulp. The topical reagents, however, take time to block the tubules, and the results are not long lasting.

Lasers have the ability to partially or fully occlude the dentinal tubules and result in longer lasting relief of dental hypersensitivity. See, e.g., Vicky Ehlers, Claus-Peter Ernst, Martina Reich, Philipp Kammerer, Brita Willershausen, (2012) Clinical comparison of Gluma and Er:YAG laser treatment of cervically exposed hypersensitive dentin, American Journal of Dentistry, 25: 3; Chuan-Hang Yu, and Yu-Chao Chang, (2014) Clinical efficacy of the Er:YAG laser treatment on hypersensitive dentin, J. Formoson Med. Association, 113: 388-391; C Zhang 1, K Matsumoto, Y Kimura, T Harashima, F H Takeda, H Zhou, (1998) Effects of CO2 laser in treatment of cervical dentinal hypersensitivity, J Endod, 24(9):595-7; and S. He, Y. Wang, X. Li, and D. Hu, (2011), Effectiveness of laser therapy and topical desensitising agents in treating dentine hypersensitivity: a systematic review, J. Oral Rehab. 38:348-358, each incorporated by reference herein in its entirety.

Lasers also have analgesic effect to bring instant pain relief. It has been demonstrated in multiple studies that applying topical agents to the sensitive area of the teeth before or after laser irradiation results in enhanced effects of the topical reagents. See He et al.

One disadvantage of laser light desensitivity methods is an undesirable heating of the hard tissue and of the pulp, possibly leading to irreversible damage of pulp. In particular, lasers such as Er:YAG and Nd:YAG that are primarily absorbed by water rather than hydroxyapatite penetrate deep in dental hard tissue, and subsequently may cause undesired damage to the tooth in the process of occluding the tubules.

CO₂-laser operating at the wavelength of 9.3 μm has been demonstrated by Featherstone and co-workers to enhance caries resistance of a tooth by modifying the enamel surface. In particular, hydroxyapatite in dental hard tissue absorbs the CO₂-laser wavelengths of 9.3 μm a factor of ten more than the conventional 10.6-μm CO₂-laser wavelengths due to the strong absorption of hydroxyapatite at this wavelength. This results in high absorption in dentin, leading to surface modification of dentin without penetrating deep inside. See, e.g., Fried D, Zuerlein MJ, Le CQ, Featherstone JD, (2002) Thermal and chemical modification of dentin by 9-11-μm CO₂ laser pulses of 5-100-μs duration. Lasers Surg Med. 31(4):275-282; and Kimura Y, Takahashi-Sakai K, Wilder-Smith P, Krasieva TB, Liaw LHL, Matsumoto K. (2000) Morphological study of the effects of CO₂ laser emitted at 9.3 μm on human dentin. J Clin Laser Med Surg. 18(4):197-202, each incorporated by reference herein in its entirety.

### SUMMARY OF THE INVENTION

In view of the foregoing, it is desirable to provide a treatment that relieves teeth sensitivity without weakening or damaging the structure of the teeth. The inventors have developed methods to occlude dentinal tubules safely at a low irradiation fluence, to treat dental hypersensitivity without damaging the pulp of the tooth. The inventors have also identified suitable methods for energy delivery to occlude the tubules. Embodiments of the present invention provide such a technique and relates to an improved laser-based method for treatment for teeth sensitivity. The laser source operates in the range of a wavelength of 9-11 μm, such as a CO₂ laser source. CO₂ lasers have several advantages over other hard tissue lasers, for example Er:YAG lasers, that have an absorption coefficient of 100 times lower in hydroxyapetite.

Embodiments of the present invention utilize a handpiece for directing irradiation (e.g., a laser beam) in the near-to far-infrared spectra (e.g., 9-11 μm wavelength range), to allow for treatment of hard tissue in the oral cavity with optimal efficiency, minimal technique sensitivity, and a fast treatment time.

The system can be adapted to scan the laser beam using any known scanning technique, e.g., galvo-mirrors. The laser beam can be scanned across the treatment region using particular pattern(s) to allow for efficient energy delivery, producing enough localized photothermal effect to heat without damaging (burning or charring) of the tissue. Such patterns are described in more detail in U.S. Patent Publication No. 20170319277, which is incorporated herein by reference in its entirety.

The system may also include a laser source controller that can adjust one or more parameters of the irradiation (e.g., laser pulse duration) according to the type of treatment selected and/or the type of tissue being treated. For example, during treatment, the laser beam may be directed to the treatment area, allowing for delivery of a specified energy profile at or near the treatment area.

In an aspect, embodiments of the invention relate to a method for treating an area of dental hard tissue to decrease sensitivity by occluding dentin tubules. The method includes generating by using a CO₂ laser source at least one pulse of a pulsed laser beam having a wavelength in a range from 9 to 11 microns. A laser beam width of the pulsed laser beam is defined and the pulsed laser beam is focused at or near the dental hard tissue area. A pulse energy of the pulsed laser beam is controlled based on the defined laser beam width, such that the at least one pulse of the pulsed laser beam has a fluence profile in a working range of the laser beam having:
a maximum local fluence less than an upper threshold fluence, the upper threshold fluence defined as a minimum fluence that causes damage of the dental hard tissue, and
at least one other local fluence greater than a lower threshold fluence, the lower threshold fluence defined as a fluence that causes a minimum amount of occlusion of the dentin tubules.
   The pulsed laser beam is directed to respective dental hard tissue locations within the hard tissue area to occlude the dentin tubules, without delivery of any cooling fluid to the dental hard tissue while directing the pulsed laser beam to respective tissue locations.

One or more of the following features may be included. The upper threshold fluence may be 3.0 J/cm². The lower threshold fluence may be at least 0.2 J/cm², e.g., at least 1.5 J/cm².

The laser may have a profile to produce fluences between lower and upper threshold fluences over a working range of 1 to 50 millimeters. The pulse energy may be in a range from 0.1 to 2.5 milli Joules. The pulse repetition rate may be in a range from 0.01 to 0.33 kHz. An average power of the CO₂ laser source may be in a range from 0.001 to 1 Watts. The laser beam may have a pulse duration in a range from 5 to 15 microseconds. The laser beam may have a beam spot size in a range from 0.3 to 1 millimeters.

A beam guidance system may be used to direct the plurality of laser pulses to the respective dental hard tissue locations in a pattern. The pattern may include a number of locations in a range from 30 to 127 locations. The pattern may include a total pattern time of 0.01 to 1 seconds. The pattern may include a first dental hard tissue location, at least one location non-adjacent to the first dental hard tissue location, and a location adjacent to the first tissue location.

At least one reagent including fluoride and/or hydroxyapatite may be applied to the dental hard tissue area, e.g., before and/or after the pulsed laser beam is directed to respective locations.

The dental hard tissue may include extracted dental hard tissue.

In another aspect, embodiments of the invention relate to a method of analyzing laser beam interaction with extracted dental hard tissue. The method includes generating by using a CO₂ laser source at least one pulse of a pulsed laser beam having a wavelength in a range from 9 to 11 microns. A laser beam width of the pulsed laser beam is defined, and the pulsed laser beam is focused at or near an area of the dental hard tissue. The pulse energy of the pulsed laser beam is controlled based on the defined laser beam width, such that the at least one pulse of the pulsed laser beam has a fluence profile in a working range of the laser beam having:
a maximum local fluence less than an upper threshold fluence, the upper threshold fluence defined as a minimum fluence that causes damage of the dental hard tissue, and
at least one other local fluence greater than a lower threshold fluence, the lower threshold fluence defined as a fluence that causes a minimum amount of occlusion of the dentin tubules.
   The pulsed laser beam is directed to respective dental hard tissue locations within the hard tissue area to occlude the dentin tubules, without delivery of any cooling fluid to the dental hard tissue while directing the pulsed laser beam to respective tissue locations. Thereafter, the resulting occlusion of the dentin tubules is analyzed.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1A is a side cross-sectional schematic view of a handpiece, suitable for use with embodiments of the invention; FIG. 1B is a photograph of the handpiece of FIG. 1A;

FIG. 2 is a side cross-sectional schematic view of a second handpiece, including an optical cartridge, suitable for use with various embodiments of the invention;

FIG. 3 is a parameter chart providing exemplary laser and treatment parameter values, according to various embodiments of the invention.

FIG. 4A-4B are photographs of samples after irradiation at 0.81 J/cm², and after washing and microbrushing, respectively, according to various embodiments of the invention;

FIGS. 5A-5F are Scanning Electron Microscope (SEM) images (at 2000× magnification) of the dentinal tubules at three different fluences corresponding no effect, some effect and full effect of irradiation on occluding the dental tubules, according to various embodiments of the invention;

FIG. 6A-6B are SEM images at 700× magnification of the edge of the irradiated region, illustrating the effect of the laser in occluding dentinal tubules, according to various embodiments of the invention;

FIG. 7 is a collection of SEM images of nine groups of treated samples showing the superior effect of irradiation with 0.81 J/cm² fluence in all groups with complete occlusion of dentinal tubules, according to various embodiments of the invention;

FIG.8 is an SEM image at 500× magnification of an edge of a dentin region to which fluoride, and irradiation+fluoride were applied, in accordance with an embodiment of the invention;

FIGS. 9A-9B are graphs showing the effect of fluences and topical reagents on dentinal tubule occlusion, in accordance with an embodiment of the invention;

FIGS. 10A-10B are an X-ray and a graph, respectively, depicting a safety study for 3 J/cm² fluence. The temperature rise was 3° C. for this worst-case scenario, below the safety limit of 4.5° C., according to various embodiments of the invention; and

FIGS. 11A-11B are very high resolution SEM images showing the occlusion effect for a fluence of 0.81 J/cm², in accordance with an embodiment of the invention.

### DETAILED DESCRIPTION

Various embodiments of the present invention are directed to an improved laser treatment method that overcomes the shortcomings of conventional methods and/or enhances the effects of conventional methods for dental sensitivity. A number of device parameters are optimized to deliver to dentin, a laser beam having a particular fluence appropriate for occluding tubules in the dentin without damaging neighboring tissue. Some advantages of the laser therapy described herein over conventional methods include additional benefits such as longevity of treatment, relief from pain and sensitivity, and improved fluoride uptake/absorption by dental hard tissue. The laser is pulsed and scanned in a certain pattern to allow optimal surface modification without any damage to the pulp.

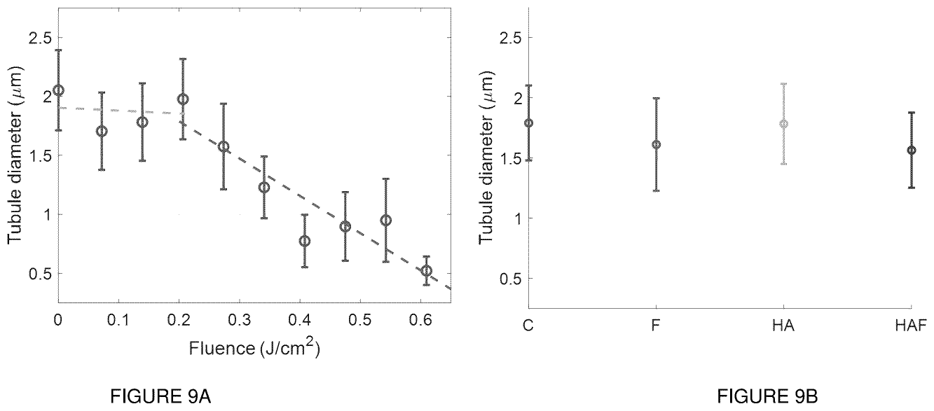

As used herein, “fluence” denotes energy density, which may be expressed in units of joules per square centimeter (J/cm²). Fluence is equal to pulse energy divided by the area of the laser beam (spot size). For each specific wavelength of radiation, typically there exists a fluence threshold for effectively occluding dental tubules. If the laser beam is pulsed, the fluence is defined as the energy per pulse divided by the cross-sectional area of the beam at the treatment location (e.g., beam spot size). For example, for a laser with a wavelength of 9.3 um and a spot size of 0.32 mm, a lower threshold fluence for melting dentin is approximately 0.2 J/cm², which was deduced from the data of FIG. 9A (discussed below). The threshold fluence is higher for other wavelengths, due to lower absorption of hydroxyapatite in dental hard tissue at other wavelengths.

A suitable device can include a hand piece that delivers (i) laser pulses to the sensitive part of the teeth to provide relief from teeth sensitivity and pain, (ii) a laser beam having a long working range (defined below), optionally (iii) coolant (air, water) to an oral treatment region, and optionally (iv) delivery system for fluoride and/or hydroxyapatite or other topical reagent application. In general, any suitable hard tissue region can be treated. For some applications, a CO₂ laser source operating at a wavelength in a range of 9-11 μm (e.g., 9.3 μm), is desirable for such treatments.

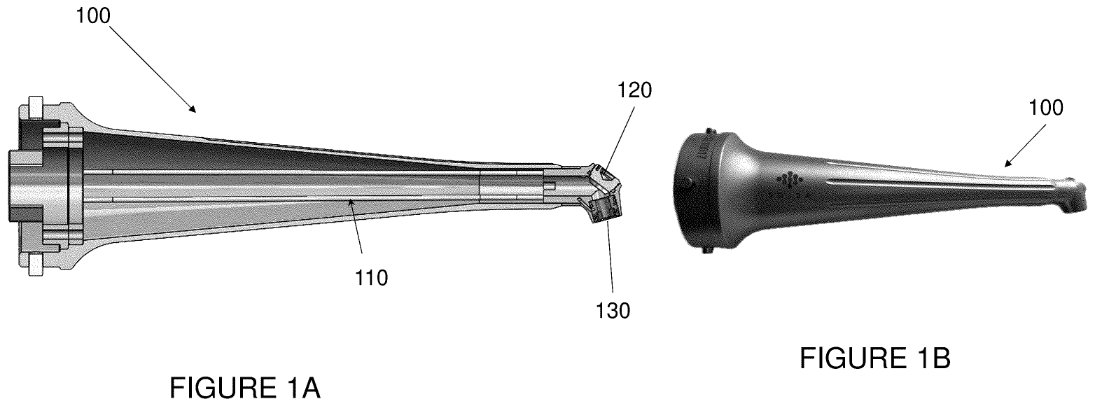

Referring to FIG. 1A and FIG. 1B, a laser beam from a CO₂ laser source (not shown) can be delivered to dentin using a handpiece 100. The handpiece can have a configuration that enables uniform treatment of all teeth with minimal change in technique sensitivity. In some embodiments, the delivery of a focused or collimated laser beam is achieved by a straight or angled handpiece 100. The handpiece includes fluid tubing 110 extending therethrough to deliver optional cooling fluids (e.g., air, water, and combinations thereof) to provide cooling of the tissue surface or to deliver a topical reagent-based fluid or gel (e.g., fluoride) to enhance desensitivity treatment. In use, topical reagents may be applied before or after the laser treatment. The handpiece 100 also includes a reflective mirror 120 that can direct the laser beam to a target, as well as an orifice 130 though which the laser beam and fluids can travel to the target. A focused laser beam may be used with a specific working range (e.g., 1 mm to 30 mm) to provide the required fluence to treat teeth sensitivity. An example of a suitable handpiece 100 is a Contra handpiece for the Solea® dental laser (depicted in FIG. 1B), available from Convergent Dental Inc., Waltham, MA.

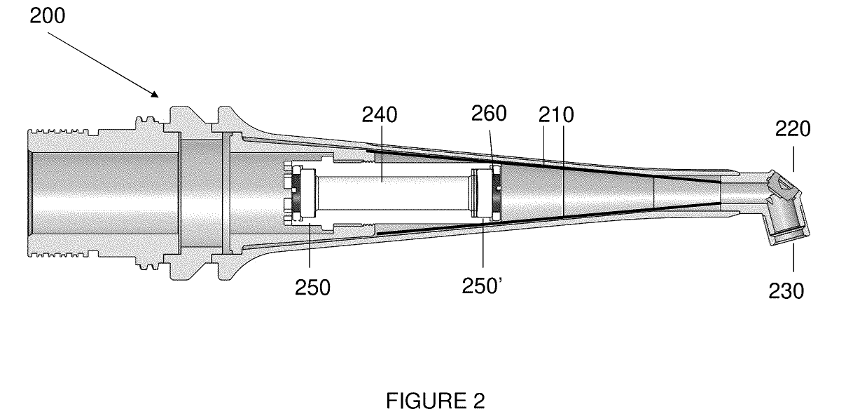

Referring to FIG. 2, a handpiece 200 may include fluid tubing 210 for delivery of fluids, a reflective mirror 220 for directing a laser beam, and an orifice 230 through which the laser beam and fluids can travel to the target. The handpiece may be structured and designed to receive an optical cartridge 240. The optical cartridge 240 can include at least one optical lens to modulate a laser beam passing therethrough. For example, as shown in FIG. 2, the optical cartridge can include an upstream optical lens 250 and a downstream optical lens 250′. The optical cartridge 240 can be mounted in the handpiece 200 at a mount interface 260 using any known technique, e.g., with a threading, magnet, etc. The ability to replace or remove the optical cartridge 240 allows switching the laser between treatment modes, such as from an ablative treatment mode to a non-ablative treatment mode and vice versa. An example of a suitable handpiece 200 with an optional cartridge 240 is the Solea® Protect™ handpiece, available from Convergent Dental Inc., Waltham, MA.

In addition, the system may use a focused beam at a fixed location with a given working range (1-30 mm), or the optical cartridge 240 can provide a laser beam having a long working range (1-50 mm). As used herein the term “working range” means the distance along the length of the laser beam at which the laser beam has a fluence capable of treating the tissue. Conventional devices have a relatively short working range, typically focused tightly around the focal point of the laser beam, out of a desire to not waste any energy along the length of the laser. The laser treatment device of some embodiments of the present invention can tolerate a longer working range, thus enabling an operator to move their hand (and, correspondingly, the laser beam), while still irradiating the treatment area. The concept of a working range is described in more detail with reference to the phrase “depth of treatment” (which can be used interchangeably with “working range”) in U.S. Patent No. 11, 291,522, which is incorporated by reference herein in its entirety. As disclosed in U.S. Pat. No. 11,291,522, column 2, lines 31-39:
The depth of treatment for a pulsed laser system can be described as the distance before, at, and after the focused waist diameter, where the energy per pulse per a cross-sectional area of the laser beam exceeds the absorption threshold of the material being treated. Laser beam equations usually call the waist radius ω₀ and thus the waist diameter is 2ω₀. In many conventional systems, the laser beam diverges from the waist at an angle so large that the depth of treatment is typically just a few millimeters.
   In other words, in certain embodiments, the amount of energy on the target tissue does not change over a relatively long distance (e.g., more than 0.5 cm, more than 1 cm, more than 1.5 cm, more than 2 cm, more than 3 cm, or more than 4 cm) to accommodate for hand movements and variability in the user's holding of the handpiece and to accommodate for human factors.

In addition, a treatment may also be performed using a handpiece without a cartridge.

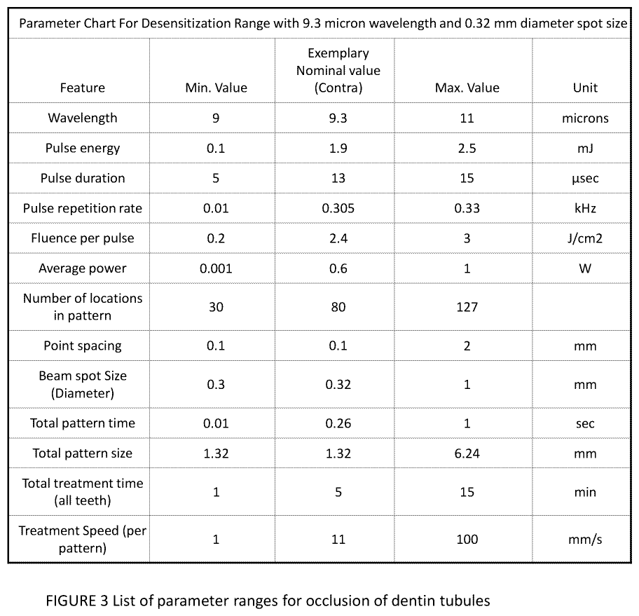

In various embodiments, laser parameters (e.g., shown in FIG. 3, power, repetition rate, pulse duration, and/or laser beam overlap) may be selected to optimize efficiency and to treat tissue without damage. Moreover, the laser source may be spatially scanned to provide different pulse energies at different locations.

In particular, an area of dental hard tissue may be treated to decrease sensitivity by occluding dentin tubules as follows. A CO₂ laser source may be used to generate at least one pulse of a pulsed laser beam having a wavelength in a range from 9 to 11 microns, e.g., 9.3 microns. A laser beam width of the pulsed laser beam may be defined. For example, the laser beam may have a beam spot size (diameter) of 0.3 to 1 mm, e.g., 0.32 mm. The pulsed laser beam may be focused at or near the tooth's surface at the dental hard tissue area. The pulse energy of the pulsed laser beam may be controlled based on the defined laser beam width so that a fluence of the laser beam that irradiates the dental hard tissue area is suitable for occluding dentin tubules. Accordingly, at least one pulse of the pulsed laser beam has a fluence profile in a working range of the laser beam having (i) a maximum local fluence less than an upper threshold fluence, the upper threshold fluence defined as a minimum fluence that causes damage, e.g., charring, cracking, or any other adverse event, of the dental hard tissue, and (ii) at least one other local fluence greater than a lower threshold fluence, the lower threshold fluence defined as a fluence that causes a minimum amount of occlusion of the dentin tubules. A minimum amount of occlusion is evidenced by a reduction in tubule diameter, as depicted in FIG. 9A.

In some embodiments, the pulse energy may be between 0.1 to 2.5 mJ, e.g., 1.9 mJ. A pulse energy of at least 0.1 mJ provides effective treatment; pulse energies greater than 2.5 mJ may result in dental damage, such as charring, cracking, and/or pulp damage. The pulse energy is preferably at least high enough to produce the maximum fluence and low enough to produce minimum fluence required to occlude the dentinal tubules. The fluence per laser pulse is preferably between 0.2 to 3 J/cm², 0.2 to 0.81 J/cm², 0.2 to 0.7 J/cm², 1.1 to 3 J/cm², or 1.5 to 3 J/cm², e.g., 2.4 J/cm². The dentin tubules typically begin to occlude at 0.2 J/cm². An upper fluence of 3 J/cm² is preferred to avoid charring dental tissue, and to avoid heating pulp to unsafe temperatures. In some embodiments, occlusion of the dentinal tubules may be defined as melting of the tubules; the melting may start at a minimum threshold fluence of, e.g., 0.2 J/cm². The pulsed laser beam is directed to respective dental hard tissue locations within the hard tissue area to occlude the dentin tubules, without delivery of any cooling fluid to the dental hard tissue while directing the pulsed laser beam to respective tissue locations. Not delivering cooling fluid during treatment provides the advantage of not subjecting sensitive dental hard tissue to a cold temperature that may cause discomfort or pain.

The laser beam may include a beam spot size (i.e., diameter) ranging from 0.3 to 1 millimeters. The desired fluence may be reached by changing the pulse energy or the area (function of diameter of the laser beam). The handpiece of FIGS. 1A-1B produces a laser beam with a diameter of 0.32 mm at the focus. In the working range of 1 to 30 mm, the beam diameter changes in a range of 0.32-1 mm. The handpiece of FIG. 2 produces a collimating beam with a 1 mm beam diameter in an entire working range of 1-50 mm.

The laser may have a profile to produce fluences between the lower and upper threshold fluences over a working range of 1 to 30 millimeters. As noted above, a longer working range enables an operator to move their hand (and, correspondingly, the laser beam), while still irradiating the treatment area.

A pulse repetition rate may be in a range from 0.01 to 0.33 kHz.

The average power of the CO₂ laser source may range from 0.0001 to 1 Watts.

The pulse duration of the pulses of the laser beam may range from 5 to 15 microseconds.

In some variations, irradiation emitted by a laser source may be transmitted through the hand piece that provides optional fluids before or after irradiation. The optional cooling fluid is carried through fluid tubings 110, 210 that run along the handpiece 100, 200 and circumvent the optional optical cartridge 240. The cooling may be useful to reduce any unintentional heating of the tissue.

In some embodiments of the invention, the fluid tubings 110, 210 carry fluoride and/or hydroxyapetite based fluids (reagents) to improve the effectiveness of the treatment before or after the laser irradiation of hard tissue that is performed through the handpiece.

In some embodiments of the invention, the combination of topical reagents, more specifically fluoride-containing gels and hydroxyapatite-containing fluids may be applied manually before or after the laser irradiation of hard tissue to enhance the desensitization effect of the laser.

In certain embodiments, the laser beam from a CO₂ laser source is accompanied with a marking beam (e.g., green in color) that serves as a guidance of the location of the laser beam on the target tissue. In other embodiments, the laser may define a pattern. A visual or sonar feedback can be integrated within the system to indicate to the user the need to move to a new target area. A visual feedback to move for a new target area can include a stationary guidance beam (e.g., a green point can be seen on the tissue). For example, while the tissue is being exposed to the laser, a pattern is displayed on the tissue. When enough dose of energy has been delivered in a pattern, the laser can stop scanning and a point object can be projected on the target tissue. Alternatively, a sonar feedback can include a sound emerging from the system when the sequence of patterns or energy dose is delivered.

In some embodiments, a beam guidance system may be used to direct the plurality of laser pulses to respective dental hard tissue locations in a pattern. A beam guidance system is a system that allows a laser beam to be moved (e.g., galvanometer mirrors) so that laser beam can be patterned. The pattern may include a number of locations, e.g., from 30 to 127 locations. Based on beam diameter and handpiece, completion of the pattern may include a total pattern time of 0.01 to 1 seconds. The pattern may include a first dental hard tissue location, at least one location non-adjacent to the first dental hard tissue location, and a location adjacent to the first tissue location.

Laser beam interactions with extracted dental hard tissue may be analyzed as follows. A laser beam having at least one pulse with a wavelength in a range from 9 to 11 microns is generated by using a CO₂ laser source. A laser beam width of the pulsed laser beam is defined, and the pulsed laser beam focused at or near an area of the dental hard tissue. The pulse energy of the pulsed laser beam is controlled based on the defined laser beam width, such that at least one pulse of the pulsed laser beam has a fluence profile of the laser beam in the working range having:
a maximum local fluence less than an upper threshold fluence, the upper threshold fluence defined as a minimum fluence that causes damage of the dental hard tissue, and
at least one other local fluence greater than a lower threshold fluence, the lower threshold fluence defined as a fluence that causes a minimum amount of occlusion of the dentin tubules.
   The pulsed laser beam is directed to respective dental hard tissue locations within the hard tissue area to occlude the dentin tubules, without delivery of any cooling fluid to the dental hard tissue while directing the pulsed laser beam to respective tissue locations. Thereafter, the resulting occlusion of the dentin tubules is analyzed.

FIG. 3 is a chart including exemplary laser and operation parameters. Laser parameters (e.g., power, repetition rate, pulse duration, and laser beam overlap) may be designed to have an optimal outcome efficiency to occlude dentinal tubule and provide relief to patients without heating the pulp to unsafe temperatures. However, the laser source may be spatially scanned to provide pulse energy at different locations, as will be appreciated by those skilled in the art.

### EXAMPLES

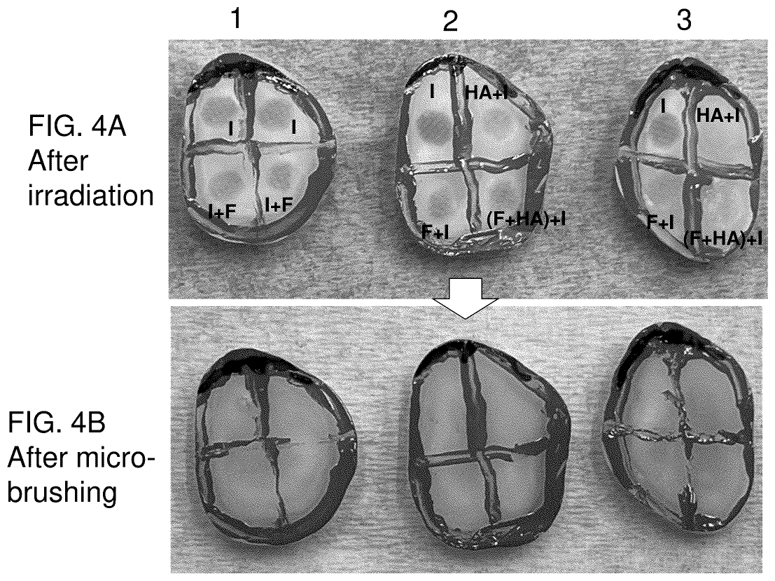

The effect of irradiation on dentinal tubule occlusion using a 9.3 μm CO₂ laser source was performed on a total of 7 human dentin samples of human teeth. The extracted sound molar teeth were obtained, cleaned, disinfected and transported in 0.1% thymol to prevent microbial growth before use (Therametric Technologies, Inc., Nobelsville, IN). Dentin samples were prepared by cutting the sound molar teeth at two locations horizontally, once at the middle of the teeth, and one at the dentin-enamel junction. The disk dentin samples were placed in 0.5M EDTA pH8 for 30 seconds, then sonicated with distilled water for 15 minutes to open up the dentinal tubules and simulate teeth sensitivity. Samples were kept in distilled water until use to keep them hydrated. Referring to FIGS. 4A and 4B, prior to use, samples were marked using nail polish and divided into 4 regions, with each region serving as a control or treatment area. For an irradiation region, the non-irradiated region served as a control. For a topical reagent region, the non-irradiated region served as topical reagent only region and the irradiated region served as irradiation+topical regent region. A total of 8 regions can be obtained from a single dentin sample, which improves the accuracy of the results. Four samples were used to study the effect of fluence on the occlusion of dentinal tubules, and three samples were used to study the effect of irradiation and topical reagents. FIGS. 4A-4B are photographs of the samples after irradiation at 0.81 J/cm², and after washing and microbrushing, respectively, illustrating that frosting produced during irradiation can be safely removed.

The samples were moistened after marking using distilled water and stored in distilled water till use. For Fluoride, 2% Sodium Fluoride gel was used (Medicom Denticare Pro-Gel). For HA, Fluidinovas nanoXIM.CarePaste was used. This is an aqueous solution of 15.5% by weight the nanoparticles of hydroxyapatite.

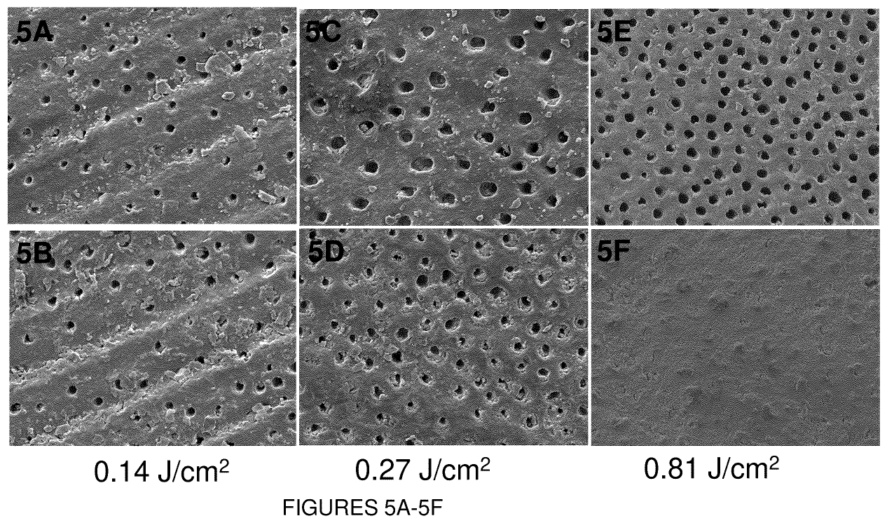

Referring to FIGS. 5A-5F, to study the effect of fluence, samples were irradiated with different fluences in the range 0-1 J/cm². SEM images (2000× magnification) at three different fluences demonstrate the effect of fluence on occlusion of tubules. In particular, the control group samples appear in the top row (FIGS. 5A, 5C, and 5E). The irradiated regions appear below, with the sample of FIG. 5B having been irradiated at 0.14 J/cm², the sample of FIG. 5D irradiated at 0.27 J/cm², and the sample of FIG. 5F irradiated at 0.81 J/cm². The irradiated and control regions correspond to the same quarter of the dentin sample. Results show that irradiation has no detectable effect until a fluence of 0.2 J/cm² was reached. Above this level, the irradiation produces increasing occlusion of dentinal tubules with increasing fluence. Above 0.6 J/cm², complete occlusion was observed.

To study the effects of irradiation and topical reagents, a fluence of 0.81 J/cm² corresponding to complete occlusion was selected. A total of 9 groups were tested. The groups included
1. 1. C—Control (No irradiation+no treatment),
2. I—only (Radiated+no treatment),
3. F—Fluoride only (No irradiation+Fluoride treatment),
4. I+F—Irradiated then Fluoride applied for 4 min (Irradiation+Fluoride treatment),
5. F+I—Fluoride applied for 4 mins followed by laser irradiated (Fluoride treatment+Radiation),
6. HA—Hydroxyapetite only for 4 min, (No irradiation+HA treatment),
7. HA+I—Hydroxyapetite applied for 4 min followed by laser irradiated, (HA treatment+Radiation),
8. Fluoride and HA mix applied only for 4 min (No +Fluoride+HA treatment),
9. Fluoride and HA mix applied only for 4 min, then irradiated (Fluoride+HA treatment+Irradiated).

After irradiation and treatment, the samples were microbrushed with very little pressure under running distilled water to remove any frosting introduced by the radiation. This step also hydrated the samples.

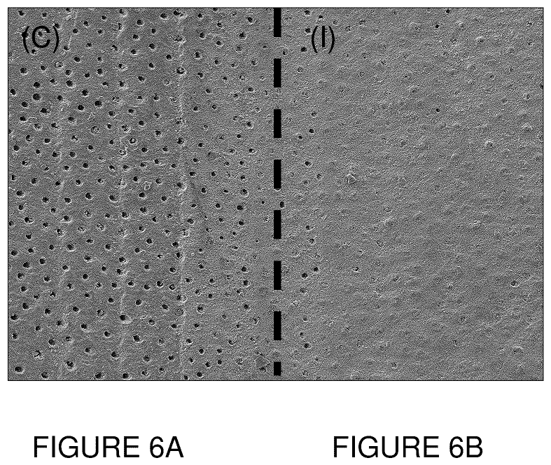

To image using SEM, dentin samples were dried, sputter coated with gold, and imaged using a Joel-7001F SEM. FIGS. 6A and 6B are SEM images at 700× magnification of an edge of an irradiation region irradiated with a fluence of 0.81 J/cm², showing control (6A) and irradiated regions (6B), respectively, clearly demonstrating the beneficial effect of irradiation in occluding dentin tubules. Near these edges the control and radiated regions of all samples were imaged at 2000× magnification to measure the tubule diameter.

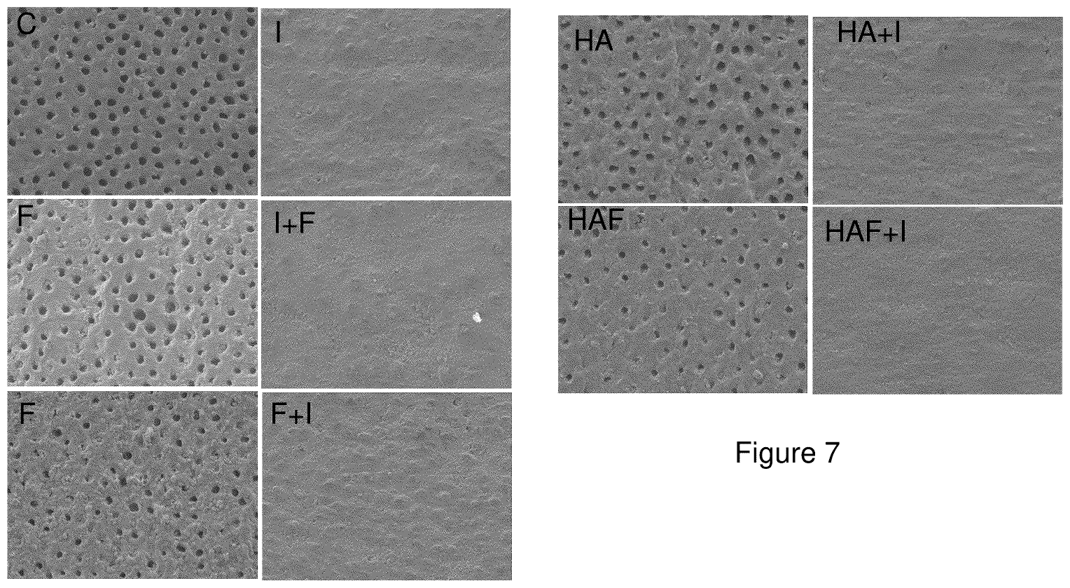

FIG. 7 includes SEM images of all nine groups of treated samples, clearly showing the superiority of laser over topical reagents in occluding dentinal tubules. More importantly, all open tubules were occluded in the irradiated samples. The irradiated samples, irradiated with 0.81 J/cm² fluence, show the superior effect of irradiation. The nine groups are listed on the corresponding images. A control region in the vicinity of an irradiated region served as a topical reagent region, while an irradiated region served as a topical reagent+irradiation region.

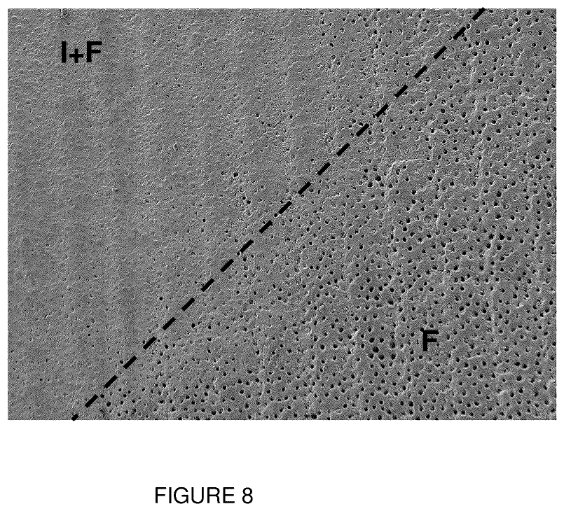

FIG. 8 is an SEM image at 500× magnification of an edge of a dentin region to which fluoride (bottom right), and irradiation with fluence of 0.81 J/cm²⁺fluoride (top left) were applied, illustrating the effectiveness of irradiation in occluding open tubules.

FIGS. 9A-9B are graphs showing the effect of fluences and topical reagents on dentinal tubule occlusion. Below a threshold fluence of 0.2 J/cm², the laser has no considerable effect on occlusion. Above this fluence, the irradiation occludes the tubules and the effects are superior compared to the topical reagents used in the study that include 2% sodium fluoride (NaF), hydroxyapetite (HA) nanoparticles, and a slurry of 2% NaF and HA nanoparticles. In particular, FIG. 9A is a plot of tubule diameter vs fluence that shows a threshold fluence of 0.2 J/cm² beyond which the tubules start to occlude. Linear fits to fluence levels below 0.2 J/cm² remain the same with an average diameter of 1.9 μm. For fluences above 0.2 J/cm², a linear fit shows a slope of 3.2 μm/(J/cm²) occlusion. Above 0.6 J/cm², a complete occlusion of tubules was observed. FIG. 9B is a plot of tubule diameter for different topical reagents: fluoride (F), hydroxyapatite (HA) and combination of both (HAF).

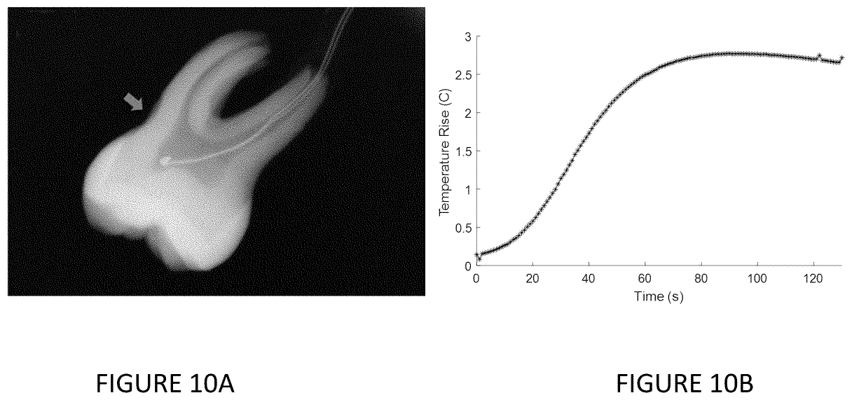

FIGS. 10A-10B are an X-ray and a graph, respectively, depicting a pulpal safety study for a fluence of 3 J/cm². In particular, FIG. 10A is an x-ray of a sample with a thermal probe inserted into the pulp. The arrow indicates the region with exposed dentin. FIG. 10B is a graph showing that the temperature rise was less than 3° C. for this worst-case scenario, below the safety limit of 4.5° C.

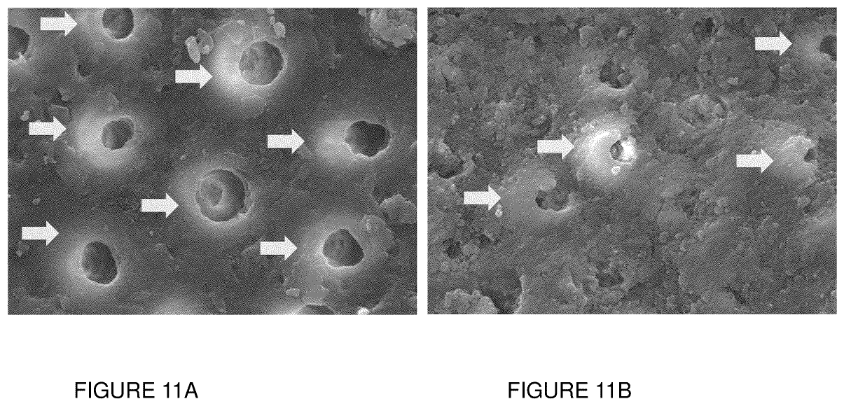

FIG. 11A is a very high resolution SEM image at 5000× magnification of non-irradiated dentin, with arrows indicating open tubules. In contrast, FIG. 11B is an SEM image clearly showing the occlusion effect for a fluence of 0.81 J/cm², with arrows indicating occluded tubules.

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein (including in any charts in the specification or figures), is contemplated and expressly supported herein, subject to the number of significant digits expressed in each particular range.

Having described herein illustrative embodiments of the present invention, persons of ordinary skill in the art will appreciate various other features and advantages of the invention apart from those specifically described above. It should therefore be understood that the foregoing is only illustrative of the principles of the invention, and that various modifications and additions, as well as combinations and permutations, can be made by those skilled in the art without departing from the spirit and scope of the invention. Any description above using the word “is” or “must” or similar language should be understood as only being within the context of a particular embodiment and not limiting of the invention. Accordingly, the appended claims shall not be limited by the particular features that have been shown and described but shall be construed also to cover any obvious modifications and equivalents thereof.

What is claimed is:

1. A method for treating an area of dental hard tissue to decrease sensitivity by occluding dentin tubules, the method comprising the steps of:
generating by using a CO₂ laser source at least one pulse of a pulsed laser beam having a wavelength in a range from 9 to 11 microns;
defining a laser beam width of the pulsed laser beam and focusing the pulsed laser beam at or near the dental hard tissue area;
controlling pulse energy of the pulsed laser beam based on the defined laser beam width, such that the at least one pulse of the pulsed laser beam has a fluence profile in a working range of the laser beam having:
a maximum local fluence less than an upper threshold fluence, the upper threshold fluence defined as a minimum fluence that causes damage of the dental hard tissue, and
at least one other local fluence greater than a lower threshold fluence, the lower threshold fluence defined as a fluence that causes a minimum amount of occlusion of the dentin tubules; and
directing the pulsed laser beam to respective dental hard tissue locations within the hard tissue area to occlude the dentin tubules, without delivery of any cooling fluid to the dental hard tissue while directing the pulsed laser beam to respective tissue locations.

2. The method of claim 1, wherein the upper threshold fluence is 3.0 J/cm².

3. The method of claim 1, wherein the lower threshold fluence is at least 0.2 J/cm².

4. The method of claim 3, wherein the lower threshold fluence is at least 1.5 J/cm².

5. The method of claim 1, wherein the laser has a profile to produce fluences between lower and upper threshold fluences over a working range of 1 to 50 millimeters.

6. The method of claim 1, wherein the pulse energy is in a range from 0.1 to 2.5 milliJoules.

7. The method of claim 1, wherein the pulse repetition rate is in a range from 0.01 to 0.33 kHz.

8. The method of claim 1, wherein an average power of the CO₂ laser source is in a range from 0.001 to 1 Watts.

9. The method of claim 1, wherein the laser beam comprises a pulse duration in a range from 5 to 15 microseconds.

10. The method of claim 1, wherein the laser beam comprises a beam spot size in a range from 0.3 to 1 millimeters.

11. The method of claim 1, further comprising using a beam guidance system to direct the plurality of laser pulses to the respective dental hard tissue locations in a pattern.

12. The method of claim 11, wherein the pattern comprises a number of locations in a range from 30 to 127 locations.

13. The method of claim 11, wherein the pattern comprises a total pattern time of 0.01 to 1 seconds.

14. The method of claim 11, wherein the pattern comprises a first dental hard tissue location, at least one location non-adjacent to the first dental hard tissue location, and a location adjacent to the first tissue location.

15. The method of claim 1, further comprising applying at least one reagent comprising at least one of fluoride or hydroxyapatite to the dental hard tissue area.

16. The method of claim 15, wherein the at least one reagent is applied before the pulsed laser beam is directed to respective locations.

17. The method of claim 15, wherein the at least one reagent is applied after the pulsed laser beam is directed to respective locations.

18. The method of claim 1, wherein the dental hard tissue comprises extracted dental hard tissue.

19. A method of analyzing laser beam interaction with extracted dental hard tissue, the method comprising the steps of:
generating by using a CO₂ laser source at least one pulse of a pulsed laser beam having a wavelength in a range from 9 to 11 microns;
defining a laser beam width of the pulsed laser beam and focusing the pulsed laser beam at or near an area of the dental hard tissue;
controlling pulse energy of the pulsed laser beam based on the defined laser beam width, such that the at least one pulse of the pulsed laser beam has a fluence profile in a working range of the laser beam having:
a maximum local fluence less than an upper threshold fluence, the upper threshold fluence defined as a minimum fluence that causes damage of the dental hard tissue, and
at least one other local fluence greater than a lower threshold fluence, the lower threshold fluence defined as a fluence that causes a minimum amount of occlusion of the dentin tubules;
directing the pulsed laser beam to respective dental hard tissue locations within the hard tissue area to occlude the dentin tubules, without delivery of any cooling fluid to the dental hard tissue while directing the pulsed laser beam to respective tissue locations; and
thereafter analyze resulting occlusion of the dentin tubules.
